(19) United States
(12) Patent Application Publication
(10) Pub. No.: US 2015/0112711 A1
(43) Pub. Date: Apr. 23, 2015

(54) HEALTHCARE ACCOUNTS RECEIVEABLE DATA VALUATOR

(71) Applicant: Revenue Management Solutions, LLC, Oklahoma City, OK (US)

(72) Inventors: Tom Dean, Oklahoma City, OK (US); Todd Slocumb, Oklahoma City, OK (US)

(73) Assignee: Revenue Management Solutions, LLC, Oklahoma City, OK (US)

(21) Appl. No.: 14/581,493

(22) Filed: Dec. 23, 2014

Related U.S. Application Data
(63) Continuation of application No. 12/759,385, filed on Apr. 13, 2010, now abandoned.

(51) Int. Cl. G06Q 40/00; G06F 19/00; G06Q 50/22

(52) U.S. Cl. CPC G06Q 40/12; G06Q 50/22; G06F 19/328
USPC 705/2

(57) ABSTRACT

A healthcare accounts receivable valuation data consolidator (valuator or valuation engine) receives and/or fetches data and uses the data to predict and share the valuation of claims submitted by a healthcare provider (e.g., hospital, doctor, dentist, lab, durable medical equipment provider, etc.) on behalf of a claimant (e.g., patient), wherein the claimant has a payer (e.g., insurance company, government program, etc.). The valuator established or generates and shares the predicted valuation between entities.

### RELATED APPLICATION

This application is a continuation of U.S. patent application Ser. No. 12/759,385, filed on Apr. 13, 2010, which claims the benefit of priority from U.S. Patent Application Ser. No. 61/171,798, filed Apr. 22, 2009, the entire contents of which are each incorporated herein by reference.

### TECHNICAL FIELD

Embodiments herein relate to the healthcare industry and, more particularly, provide a system for accurately estimating the values of healthcare receivables and consolidating healthcare data for access by participants in the settlement process.

### BACKGROUND

The processing of accounts receivable information in the healthcare industry is very complex in comparison with most other industries. In most cases, a third party like the government (Medicaid or Medicare) or a private health insurance company is the primary payer for the services provided to a patient. In many of these cases a doctor and/or a hospital will have a contract with the third party payer. This contract details the amount the payer will pay for various diagnoses or treatment procedures. Many other factors affect the amount paid by the third party. Some procedures require pre-authorization by the payer; others require a referral by another healthcare professional. In many cases, proof that the patient is eligible or actually has the insurance coverage at the time the patient is treated is also important.

Any given provider can have contracts with many different health insurance companies. Each insurance company can have many different lines or types of insurance. Each type of insurance can pay a slightly different amount for a given procedure based on the contract negotiated between the healthcare provider and the insurance company. Because it is so cumbersome to identify the precise amount to bill, healthcare providers will typically bill a standard amount for each procedure. Because of this, the provider often does not get paid the amount billed.

All of the factors above combine to present a problem for the healthcare provider, the provider's bank, the third party payer, the patient, third party collection agents, and/or other organizations for which the cumulative administrative data related to claims and payments may be useful. The problem includes the fact that the provider does not know the true value of the receivables. Because of this, the provider's bank has no good way of lending or funding receivables. Another problem is that neither the payer nor the payer's bank has a basis for expediting the payment for the provider's claim. Increasingly the patient needs a view of this information because of the increased number of high deductible insurance plans that require the patient to be responsible for the payment before the deductible is met. Third party collection agents would also benefit from better information related to the expected value of a receivable that they are contracted to collect. Finally, there is much valuable information related to the claim and the payment that, when viewed in the aggregate, could assist in increasing the quality of healthcare and/or decreasing the cost. Consequently, there is a need for a system that accurately estimates the values of healthcare receivables and consolidates the attendant data so that it can be properly viewed by the various participants in the settlement process.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE FIGURES

FIG. 1 shows the valuator as the single source for all payer remittances in a healthcare receivables environment, under an embodiment.

FIG. 2 is a block diagram of a healthcare receivables system including the valuator, under an embodiment.

FIG. 3 is a flow diagram of claim valuation, under an embodiment.

### DETAILED DESCRIPTION

Systems and methods are described herein for funding healthcare receivables and are collectively referred to as a healthcare accounts receivable valuation data consolidator (referred to herein as valuator, valuation engine or consolidator). The valuator is configured to receive and/or fetch data and use the data to predict and share the valuation of claims submitted by a healthcare provider (e.g., hospital, doctor, dentist, lab, durable medical equipment provider, etc.) on behalf of a claimant (e.g., patient), wherein the claimant has a payer (e.g., insurance company, government program, etc.). The valuator established or generates and shares the predicted valuation between entities. The term “healthcare” as used herein refers to any field or enterprise concerned with supplying services, equipment, and/or information for the maintenance or restoration of health.

In contrast to conventional systems for handling healthcare receivables, the valuator provides a unique matching process that creates or generates the best estimate of the value of a healthcare receivable. The valuator also uniquely provides consolidation of the attendant information of the healthcare receivables so that the information can be accessed by all of parties involved in the healthcare process. Furthermore, the valuator provides a filter for each party involved in the healthcare process that is sensitive to the data required and the regulatory restrictions to accessing specific data, particularly private health information.

The valuator of an embodiment is configured to enable prediction of healthcare claim valuations. The valuator is also configured to enable sharing of healthcare accounts receivable or payable information between payers, providers, banks, buyers and/or sellers of healthcare accounts receivables. The valuator is generally configured to perform one or more of valuation of the receivable, financial scoring of the receivable, bidding on receivables, and sharing receivable information without sharing private information related to the individual(s) corresponding to the receivable.

The valuator of an embodiment is configured to receive and/or fetch healthcare claim and remittance advice data from healthcare providers or their agents in the form of ANSII standard X.12.837 and/or X.12.835 EDI transactions, proprietary non-standard electronic data comprised of similar information as the standards, or their paper equivalents. The valuator is configured to receive and/or fetch other relevant transaction data submitted by the provider, for example, eligibility and preauthorization transactions if they exist. The received data is automatically (e.g., electronically) scrubbed or otherwise redacted in order to eliminate information that identifies a person to whom the data corresponds. Related transactions are automatically marked to indicate an association, following the scrubbing. The valuator is configured to share the scrubbed transaction data with appropriately identified entities (e.g., hospitals, doctors, health insurance companies, banks, agents, buyers and sellers of healthcare receivables, etc.) via a network.

The valuator of an embodiment is configured to receive and/or fetch claim(s) from a provider in the form of an ANSII X.12.837 transaction or the paper equivalent. The valuator is configured to receive and/or fetch other relevant transactions submitted by the provider, including eligibility and preauthorization transactions if they exist. The valuator is configured to receive and/or fetch pricing contracts the provider has with any payer entities and/or payment schedules published by government entities. The valuator is configured to receive and/or fetch historical data related to actual payments made by insurance companies to providers for each specific procedure. The valuator is configured to receive and/or fetch auto-adjudication or pre-adjudication information from the payer.

The valuator is configured to use information from the eligibility and claim transaction to gain pricing information from the provider's contract and the historical data base for use in estimating the value of each claim. The valuator is configured to automatically (e.g., electronically) reconcile the contract price/historical information to the adjudication information provided by the payer. The valuator is configured to share via a network the information with the appropriate provider, payer and/or the provider's bank for purposes of more accurately valuing the provider's receivables and possibly accelerating payment to the provider.

In the following description, a number of features are described in detail in order to provide a more thorough understanding of the embodiments described herein. It is apparent that these embodiments may be practiced without these specific details. In other cases, well known features have not been described in detail.

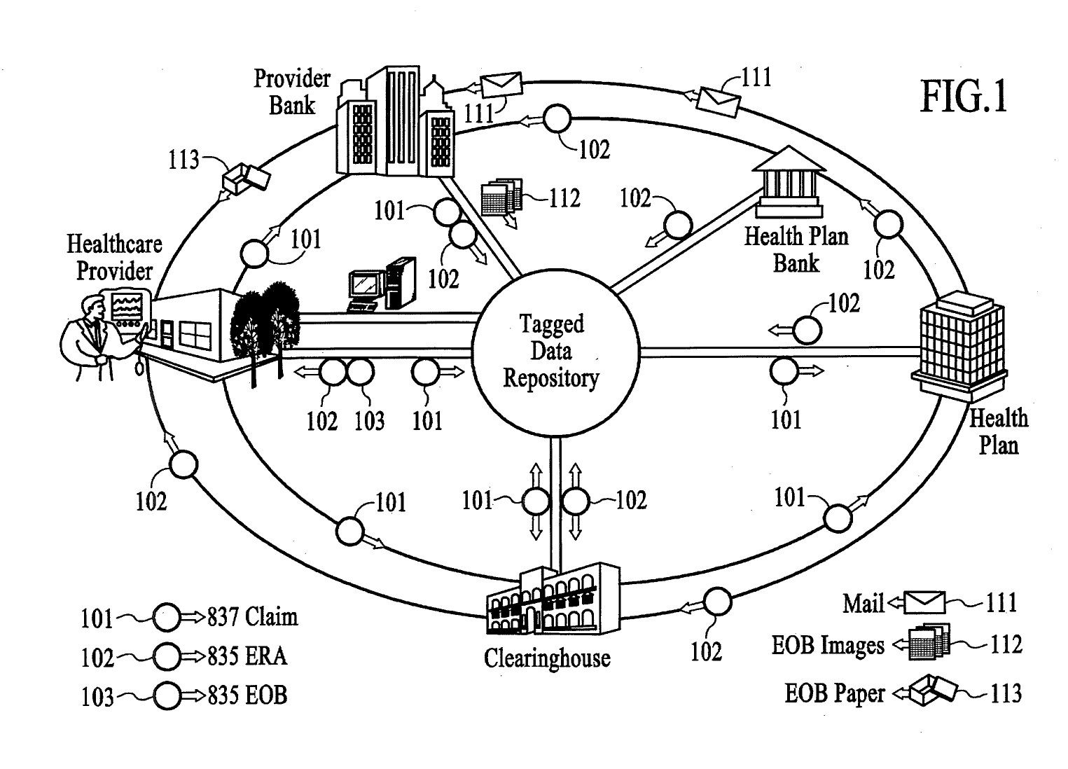

FIG. 1 shows the valuator as the single source for all payer remittances in a healthcare receivables environment, under an embodiment. The environment of an embodiment is compliant with the Health Insurance Portability and Accountability Act of 1996 (HIPAA) but is not so limited. HIPAA contains provisions to protect the confidentiality and security of personally-identifiable information that arises in the course of providing health care. The valuator securely exchanges data or participates in secure transactions with the participants in the healthcare receivables process. The transactions include but are not limited to 837 Claims Transactions (837 Claim), Electronic Remittance Advice (ERA) 835 transactions (835 ERA), ERA 835 transaction explanation of benefits (EOB) (835 EOB), and electronic funds transfer (EFT) transactions. Communications with the valuator and third-party systems in the transactions above are made using network couplings or connections made via public or private networks. Using the various transactions above, the valuator generally gathers then reconciles claims, remittance advices (electronic or paper), and the funds to deliver a balanced HIPAA compliant ERA for automated posting. The platform supports automated secondary billing, denial management, and contract management functions.

Generally, in a healthcare receivables environment, each time a patient visits their healthcare provider (patient encounter), the provider generates a claim (bill) 101 from their accounts receivable or billing system. The claim 101 goes to the primary payer, which is generally a commercial insurance company or the government. If the patient has does not have insurance or is not covered by a government program then the bill will be sent to the patient for payment. A claim 101 is generated by the patient billing system but it is not sent to a third party for payment. If the patient has insurance or is covered by a government program then a claim 101 will be sent to a third party payer or “payer” (e.g., Medicare, Medicaid, Blue Cross Blue Shield, Aetna, Cigna, etc.) for payment. The provider can send the claims 101 directly to the third party but claims 101 are usually sent from the provider to a healthcare claims clearinghouse and then the claims 101 are forwarded to the payer in the form of a HIPAA compliant format (e.g., ANSI X-12 837) for payment. When the healthcare claim 101 is sent to a payer for payment it is generally sent in one of the following formats, but is not so limited: ANSI X-12 837, UB04, CMS 1500 paper or print file, ADA form, NSF.

Turning to the Healthcare Remittance/Payment, once the claim 101 is received by the payer then it is loaded into the payers system for processing. During this processing the claim 101 is validated and then a set of rules are applied to the claim 101 in order to determine the amount to be paid to the provider. This process is called adjudication. When the payer has completed the adjudication process then adjudicated claim information is sent for use in the disbursement process.

The disbursement includes two components, the payment and remittance. Payment takes the form of a paper check, ACH, or wire transfer. The remittance takes the form of an electronic file 112 or, alternatively, a paper form 113. The paper remittance 112 is called an Explanation of Payment (EOP) or Explanation of Benefits (EOB) 103, and each payer has a uniquely formatted EOP. If the remittance is an electronic remittance advice (ERA) 102 the format is an ANSI X-12 835 or in some instances is also proprietary to the Payer. The following combinations of Remittance and Payment are available, but the embodiment is not so limited: Check and EOP/EOB; ACH and EOP/EOB; Check and ERA; ACH and ERA.

The valuator of an embodiment identifies types of receivables for which a patient is eligible by conducting eligibility checks for each patient. The valuator therefore functions to run eligibility checks and identify the patient as eligible for receivables from one or more of qualified payers (e.g., payers willing to join the network and feed information to the auto-adjudication system), non-qualified payers, Medicare or Medicaid, and/or patient responsibility (e.g., some or all of the payment is the patient's responsibility).

Regarding eligibility for receivables from qualified payers, the provider's contracts for these payers are entered into the valuator. For qualified payers eligibility is checked using an ANSI X.12.270 (request) and an ANSI X.12.271 transaction (response). This transaction identifies if the patient is eligible, the line of business from the payer (the contract has fee schedules based on line of business), the balance of the patient deductible, and/or co-pay amounts if the line of business requires them. Based on the contract, other transactions are processed if required by the contract based on information of the claim before it is submitted. For example a referral may be required by the contract based on the CPT code on the claim. Another example is a prior authorization may be required based on the information on the claim.

Before the claim is submitted, the valuator subjects the claim to a scrubber configured to perform edits for the qualified payer. If the edits identify a claim that is coded incorrectly and would be rejected by the payer, the provider is notified and has an opportunity to correct the claim before it is submitted. When the claim is submitted to the valuator the claim is valued based on the contract between the provider and the qualified payer. The qualified payers submit information to the valuator so that, before the claim is submitted, the claim is subjected to auto adjudication. The result is a value for the claim along with a value for the patient responsibility. If the contract system value and the auto-adjudication system value match, the claim is “fundable” in a pre-specified period of time (e.g., 48 hours). During the pre-specified funding time the valuator checks against fraud filters to identify fraudulent claims.

For recourse funding, the eventual amount paid is verified against the amount funded. Additionally, for recourse funding the adjustment is made before the next day's disbursements to the provider.

Claims that are not fundable either because they are not for qualified payers or because the auto-adjudication predicted value does not match the contract predicted value are categorized and submitted to an on-line trading platform (any data elements that would identify the subject patient are removed from the data so that the data can be evaluated but no privacy is violated).

Government claims can not be bought, sold and/or factored but they can be considered as assets and valued in asset-based loans like lines of credit. This requires that the provider have an established line of credit with a bank and be able to value the claims. Therefore, the valuator of an embodiment can be used to value the claims for inclusion in asset-based lines of credit.

The valuator of an embodiment establishes a value of receivables or claims from qualified payers for a line of credit, where Medicare and Medicaid are considered qualified payers. Operation begins to establish this value by entering the provider's contracts for these payers into the valuator. For qualified payers eligibility is checked using an ANSI X.12.270 (request) and an ANSI X.12.271 transaction (response). This transaction identifies if the patient is eligible, the line of business from the payer (the contract has fee schedules based on line of business), the balance of the patient deductible, and/or co-pay amounts if the line of business requires them. Based on the contract, other transactions are processed if required by the contract based on information of the claim before it is submitted. For example a referral may be required by the contract based on the CPT code on the claim. Another example is a prior authorization may be required based on the information on the claim.

Before the claim is submitted, the valuator subjects the claim to a scrubber configured to perform edits for the qualified payer. If the edits identify a claim that is coded incorrectly and would be rejected by the payer, the provider is notified an has an opportunity to correct the claim before it is submitted. When the claim is submitted to the valuator the claim is valued based on the contract between the provider and the qualified payer. The qualified payers submit information to the valuator so that, before the claim is submitted, the claim is subjected to auto adjudication. The result is a value for the claim along with a value for the patient responsibility. If the contract system value and the auto-adjudication system value match, the claim is “verified” in a pre-specified period of time (e.g., 48 hours). During the pre-specified verification period the valuator checks against fraud filters to identify fraudulent claims. At the conclusion of the verification period the claim amount is added to the available line of credit for the provider. When the claim is subsequently paid the claim amount is automatically deducted from the provider's available line of credit.

Regarding receivables that fall into the category of patient responsibility, as described above, the valuator automatically posts the patient responsibility for qualified payers, government payers, and/or uninsured patients. Based on other demographic information gathered by the provider the valuator assesses the patient's ability to pay the amount required (e.g., the valuator can use credit checks to score each patients ability to pay, etc.). The provider is then presented options based on the patient's ability to pay as determined by the evaluator. For example, the provider can be presented one or more of the following options, but is not so limited: sell the receivable on an on-line trading platform; establish a medical credit card for qualified patients; establish a payment plan for the patient that automatically and periodically (e.g., weekly, monthly, etc.) deducts money from an established account; discount the amount owed and chose a payment strategy from those described herein; assign the service as a charitable contribution; attempt to recover some of the money owed by the patient by connect to an automated service that attempts to qualify the patient for registered government and/or charitable programs.

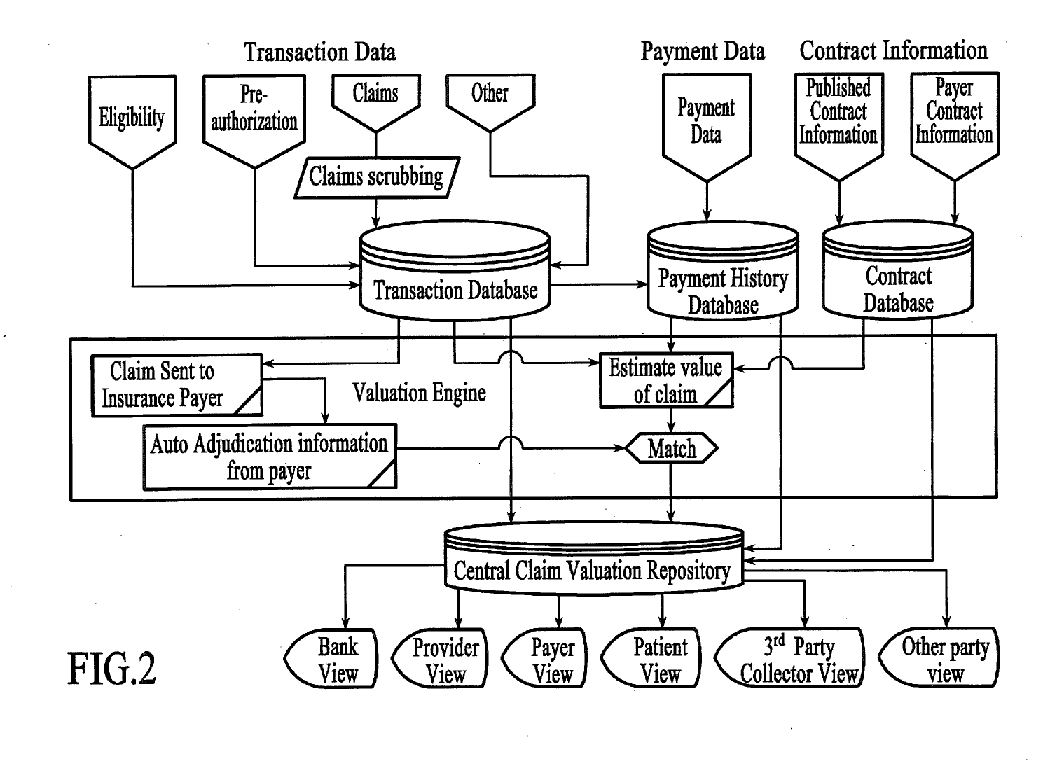

More specifically, FIG. 2 is a block diagram of a healthcare receivables system including the valuator, under an embodiment. The valuator, also referred to as the valuation engine, gathers data from disparate sources as described above. The data gathered generally includes transaction data, payer contract information, and payment data or payment history data, as described in detail below.

The transaction data includes data of a transaction between a patent and a provider. The provider's accounting system (e.g., practice management system, hospital information system, etc.) produces a claim, which is a bill for the services rendered to a patient during a visit to the provider. The valuator receives the claim information from the provider's accounting system or the provider's clearing house. Receipt of the claim information is accomplished via a file transfer that contains the data either in the form of an image of the paper claim, a print file, an ANSI standard formatted EDI file, or a non-standard format file that includes the claim information.

The valuator also gathers information about other transactions related to a patient visit. Depending on the patient and the diagnosis or treatment, these transactions include eligibility transactions that validate the exact type of insurance a patient has and that they are still in good standing with an insurance company at the time the patient visits the provider. The data of other transactions can also include any pre-authorization (e.g., provided by insurer) for a particular test or procedure indicating that the insurer agreed to pay for the procedure before it was accomplished. Furthermore, the data of other transactions can also include any data of a referral of the patient to a specialist by a general practitioner required by the patient's insurer before they will pay for the specialist's services. The data related to each patient visit is received into the transaction database.

Payer contract information or data is also received by the valuator. Providers typically have contracts with several different insurance companies. Among other things covered in the contract, the contract will contain a fee schedule that addresses the amount the insurance company will pay the healthcare provider for given procedures that the doctor or hospital may perform on a patient during a patient visit. There may also be a set of rules related to which procedures are covered by the insurance company and which procedures are not covered. This information is extracted from the contract by the valuator and loaded into the contract database along with similar information from the government (e.g., Medicare, Medicaid, etc.) that is published by procedure and geographic location.

The valuator receives payment history information and loads the payment information into a payment history database as described below. In some cases, doctors and hospitals will treat patients who have insurance plans issued by companies with which the provider does not have a contractual relationship. Services provided in these situations are often referred as “out of network” services. The insurance company typically will pay the provider a fee or a percentage of a fee based on a standard fee schedule. Over time, the payment history for given procedures that are paid by a given insurance company provides a basis for estimating the amount an insurance company will pay. The payment history information can also be a valuable predictor of future payments, even if the provider has a contract with the insurance company.

Following retrieval or gathering of the transaction data, payer contract information, and payment history data, as described above, the data is submitted to the valuator. The valuator receives feeds from the data bases described above and also receives a feed from the payers (e.g., heath insurance company, government agency, etc.) auto adjudication process. Most insurance payers pass information through an automated process that applies business rules to each claim and assigns values to the claim, This pre-adjudication is followed in some cases by other processes but the results of this process are useful in estimating the claim.

For each claim, the valuator receives transaction information from the transaction database and estimates the value of the claim. The estimate is based on information that comes from the contract database and from the payment history database. Once an estimate of the claim's value is achieved, it is matched to information received from the payer's auto adjudication process. The valuation matches the estimated value with the auto adjudication value and passes the results to a central claim valuation repository.

The valuator of an embodiment includes a scoring mechanism that enables a user to assign weights to the historical information and the contract information for each different payer of a claim in order to obtain the estimated value. The weights can be generated automatically based on information entered into the valuator or, alternatively, the valuator accepts weights entered directly by the user.

The valuator of an embodiment automatically deducts the patient's responsibility from the estimated value to obtain the judged estimated value. In particular, this automatic deduction operation is applied when the eligibility transaction data reveals that the patient owes a co-payment, a deductable amount, or has some other responsibility for a portion of the bill, but the embodiment is not so limited.

The valuator of an embodiment enables the user to assign business rules to be automatically applied by the valuator to the comparison of the auto adjudication amount and the judged estimated value. As an example of rule assignment, if the difference between the auto adjudication amount and the judged estimated value is less than a prespecified percentage (e.g., one (1) percent, two (2) percent, etc.) of the auto adjudication amount, then the auto adjudication amount is selected for use, otherwise the sum of the estimated amount plus the auto-adjudication amount divided by two (2) is selected for use.

The central claim repository holds all of the information gathered and all of the results of the various processes applied by the valuator. The information available through the central claim repository includes all transactions related to a particular claim. The central claim repository also includes the history of payments made by an insurance company for the same procedure(s) of a claim. The central claim repository further includes the results of a claim valuation estimate based on payment history and the provider's contract. Moreover, the information available through the central claim repository includes the results of the payer's auto adjudication/pre-adjudication process;

additionally, the central claim repository includes data as to how closely the claim valuation estimates match the auto adjudication result. The information available through the central claim repository also includes data as to existence of a record of the transactions (e.g., referrals, pre-authorizations, eligibility, etc.) required by contract by the payer. Furthermore, where permissible by law, the central claim repository provides or enables analysis of aggregate information across payers and providers where the privacy of the patient is protected.

There are various stakeholders that have a need to access the data in order to conduct business, and the central claim repository controls and provides this access. These stakeholders include the healthcare provider and the payer but are not so limited. They also include the payer or the provider's bank, the patient, a third party collector, and/or other parties for which the ability to access and analyze the aggregate data may be useful. An example of an entity that may wish to analyze the data includes the Center for Disease Control when evaluating the rate at which a disease spreads based on the data of the central claim repository. Another example includes the American Hospital Association or a similar organization that may be analyzing the data in order to suggest best practices to their members based on data in the central claim repository.

When accessing data of the central claim repository, the valuator enables each party to access and view data based on the party's requirement to see the data but taking into account any regulatory requirements related to the information that can be viewed.

For instance a provider and a patient may be able to view private health information that, as a result of HIPAA or other regulations or restrictions, a bank may not view. Aggregate data may be further restricted with respect to the identity of the patient and in some cases even the payer and or the provider.

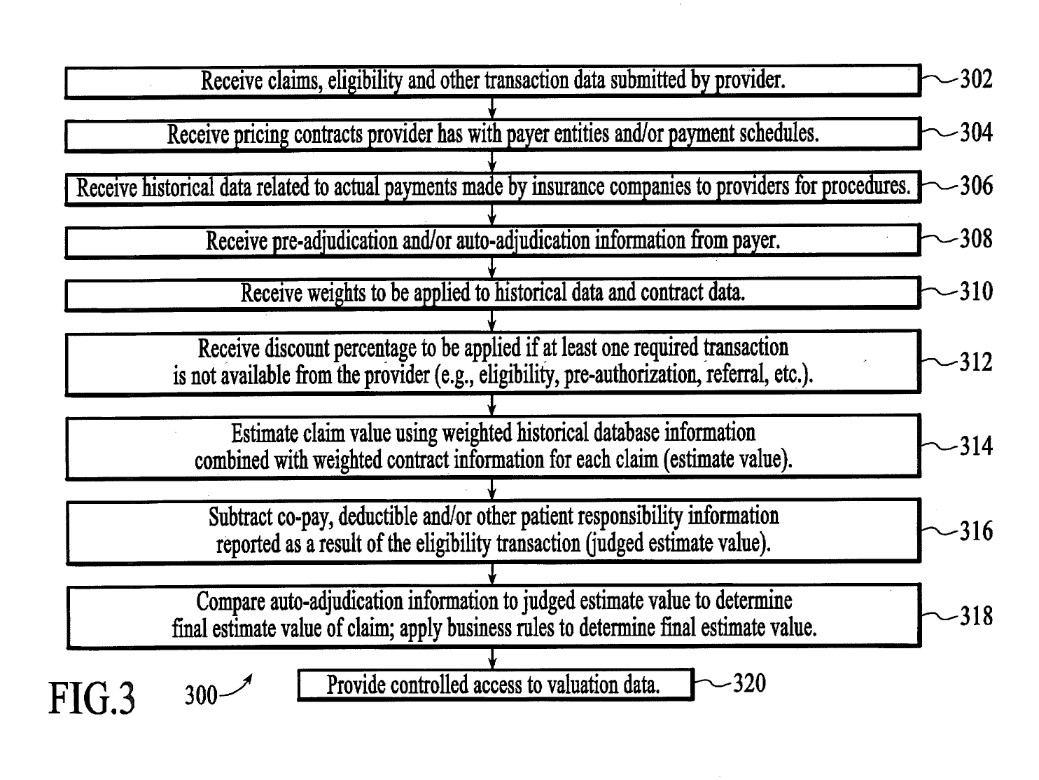

FIG. 3 is a flow diagram of claim valuation 300, under an embodiment. The valuator of an embodiment receives or fetches claim(s) from a provider, along with other relevant transactions submitted by the provider (e.g., eligibility transactions, preauthorization transactions, etc.) 302. The valuator receives or fetches pricing contracts the provider has with any payer entities and/or payment schedules published by government entities 304. Historical data related to actual payments made by insurance companies to providers for each specific procedure is received or fetched 306. The valuator also receives or fetches pre-adjudication or auto-adjudication information from the payer 308. The valuator receives or fetches weights to be applied by the valuator to the historical data and the contract data 310. The valuator receives or fetches any discount percentages to be applied when one or more required transactions are not available from the provider (e.g., eligibility, pre-authorization, referral, etc.) 312. The valuator estimates the claim value using weighted historical information combined with weighted contract information for each claim to generate an estimate value or predicted value 316. The valuator subtracts from the estimate value any co-pay, deductible and/or other patient responsibility amount reported as a result of the eligibility transaction, and the resulting value is the judged estimate value 318. The valuator compares the auto-adjudication information to the judged estimate value to determine the final estimate value of the claim 320. In generating the final estimate value of the claim, the valuator can apply business rules to the comparison of the auto adjudication amount and the judged estimated value. The valuator provides 320 the final estimate value via controlled access by remote client devices over a network.

Embodiments described herein include a system comprising: a valuation engine comprising at least one processor and at least one database coupled to a plurality of remote clients via a network; wherein the valuation engine receives a claim that includes transaction data of a transaction between a provider of healthcare services and a claimant; wherein the valuation engine receives contract data of at least one contract between the claimant and a payer; wherein the valuation engine receives payment data that includes data of actual payments made by a plurality of payers for the healthcare services; wherein the valuation engine predicts a value of the claim from the contract data and the payment data; and wherein the valuation engine provides controlled electronic access to the value by at least one third party.

The transaction of an embodiment is treatment of the claimant by the provider.

The valuation engine of an embodiment receives the claim via an electronic file transfer from a remote client of the provider.

The valuation engine of an embodiment receives adjudication data from a remote client of the payer.

The valuation engine of an embodiment generates a predicted value of the claim by automatically reconciling the contract data and the payment data with the adjudication data.

The at least one database of an embodiment comprises a transaction database, wherein the valuation engine stores the claim in the transaction database.

The valuation engine of an embodiment stores the transaction data in the transaction database.

The at least one database of an embodiment comprises a payment database, wherein the valuation engine stores the payment data in the payment database.

The at least one database of an embodiment comprises a contract database, wherein the valuation engine stores the contract data in the contract database.

The at least one database of an embodiment comprises a valuation repository, wherein the valuation engine stores the contract data in the valuation repository.

The valuation engine of an embodiment provides controlled access to accounts receivable data of the provider to the at least one third party via a remote client of the at least one third party.

The valuation engine of an embodiment generates a financial score corresponding to the accounts receivable data.

The valuation engine of an embodiment enables electronic bidding on at least one account in the accounts receivable data.

The transaction data of an embodiment comprises data of an eligibility transaction that validates a type of insurance held by the claimant and a status of the insurance.

The eligibility transaction of an embodiment determines the claimant is responsible for a portion of a claim amount, the valuation engine automatically deducts the portion of the claim amount from the value.

The transaction data of an embodiment comprises data of a preauthorization transaction that includes payer preapproval for the healthcare services.

The transaction data of an embodiment comprises data of a referral corresponding to the healthcare services.

The valuation engine of an embodiment redacts claimant identification data from the claim.

The valuation engine of an embodiment identifies related transactions that correspond to at least one of the claimant, the provider, the payer, and the healthcare services.

The valuation engine of an embodiment automatically determines eligibility for the healthcare services corresponding to the claim.

The valuation engine of an embodiment identifies at least one type of receivable for which the claimant is eligible from at least one payer.

In generating the predicted value, the valuation engine of an embodiment evaluates the claim by using the claim and eligibility data to gain pricing information from the contract data.

The valuation engine of an embodiment automatically generates secondary billing corresponding to the transaction.

The valuation engine of an embodiment automatically manages denial of the claim.

The valuation engine of an embodiment automatically controls an available line of credit of the provider using the predicted value of the claim.

The valuation engine of an embodiment automatically generates a claimant responsibility amount corresponding to the claim.

The valuation engine of an embodiment, using demographic data, determines an ability of the claimant to pay the claimant responsibility amount.

The valuation engine of an embodiment receives at least one weight coefficient.

The valuation engine of an embodiment applies the at least one weight to the contract data to determine the value.

The valuation engine of an embodiment applies the at least one weight to the payment data to determine the value.

In the absence of transaction data from at least one transaction, the valuation engine of an embodiment receives a discount percentage and applies the discount percentage to the claim.

The valuation engine of an embodiment predicts the value by comparing auto-adjudication information to the value.

Embodiments described herein include a method comprising: receiving a claim that includes transaction data of a transaction between a provider of healthcare services and a claimant; receiving contract data of at least one contract between the claimant and a payer; receiving payment data that includes data of actual payments made by a plurality of payers for the healthcare services; automatically generating a predicted value of the claim from the contract data and the payment data; and providing controlled electronic access to the value by at least one third party.

The method of an embodiment comprises receiving adjudication data from the payer.

The generating of the predicted value of an embodiment comprises automatically reconciling the adjudication data with the contract data and the payment data.

The at least one third party of an embodiment is one or more of the payer, a third party payer, the provider, a third party provider, a financial institution, a buyer of accounts receivable, and a seller of accounts receivable.

The method of an embodiment comprises automatically generating a financial score corresponding to the claim.

The method of an embodiment comprises providing controlled access to accounts receivable data of the provider to the at least one third party.

The method of an embodiment comprises automatically generating a financial score corresponding to the accounts receivable data.

The method of an embodiment comprises conducting electronic bidding on at least one account in the accounts receivable data.

The transaction data of an embodiment comprises data of an eligibility transaction that validates a type of insurance held by the claimant and a status of the insurance.

When the eligibility transaction of an embodiment determines the claimant is responsible for a portion of a claim amount, the valuation engine automatically deducts the portion of the claim amount from the value.

The transaction data of an embodiment comprises data of a preauthorization transaction that includes payer preapproval for the healthcare services.

The transaction data of an embodiment comprises data of a referral corresponding to the healthcare services.

The method of an embodiment comprises automatically redacting claimant identification data from the claim.

The method of an embodiment comprises automatically identifying related transactions that correspond to at least one of the claimant, the provider, the payer, and the healthcare services.

The method of an embodiment comprises automatically determining eligibility for the healthcare services corresponding to the claim.

The method of an embodiment comprises automatically determining eligibility of the claimant for the healthcare services.

The method of an embodiment comprises automatically determining eligibility for receivables from at least one payer.

The method of an embodiment comprises automatically identifying at least one type of receivable for which the claimant is eligible from at least one payer.

The transaction of an embodiment is treatment of the claimant by the provider.

The generating of the predicted value of an embodiment comprises evaluating the claim by using the claim and eligibility data to gain pricing information from the contract data.

The method of an embodiment comprises automatically generating secondary billing corresponding to the transaction.

The method of an embodiment comprises automatically managing claim denial corresponding to the transaction.

The method of an embodiment comprises automatically managing the at least one contract.

The method of an embodiment comprises adding the predicted value of the claim to an available line of credit of the provider.

The method of an embodiment comprises subtracting the predicted value of the claim from the available line of credit of the provider when the claim is paid.

The method of an embodiment comprises automatically generating a claimant responsibility amount corresponding to the claim.

The method of an embodiment comprises, using demographic data, determining an ability of the claimant to pay the claimant responsibility amount.

The method of an embodiment comprises, using the ability of the claimant to pay, generating at least one option under which the provider receives payment of the claim.

The receiving of the claim of an embodiment comprises an electronic file transfer.

The method of an embodiment comprises receiving at least one weight coefficient.

The method of an embodiment comprises applying the at least one weight to the contract data to determine the value.

The method of an embodiment comprises applying the at least one weight to the payment data to determine the value.

The method of an embodiment comprises, in the absence of transaction data from at least one transaction, receiving a discount percentage and applying the discount percentage to the claim.

The predicting of the value of an embodiment comprises comparing auto-adjudication information to the value.

Embodiments described herein include a method comprising: receiving a claim that includes transaction data of a transaction between a provider of healthcare services and a claimant; receiving contract data of at least one contract between the claimant and at least one payer, wherein the at least one contract corresponds to the healthcare services provided in the transaction; receiving payment data that includes historical data of actual payments made by a plurality of payers for the healthcare services; receiving adjudication data from the payer; and generating a predicted value of the claim by automatically reconciling the contract data and the payment data with the adjudication data.

As described above, computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The valuator can be a component of a single system, multiple systems, and/or geographically separate systems. The valuator can also be a subcomponent or subsystem of a single system, multiple systems, and/or geographically separate systems. The valuator can be coupled to one or more other components (not shown) of a host system or a system coupled to the host system.

One or more components of the valuator and/or a corresponding system or application to which the valuator is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that includes the valuator can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the valuator described herein may be implemented as functionality programmed into any of a variety of circuitry, including programmable logic devices (PLDs), field programmable gate arrays (FPGAs), programmable array logic (PAL) devices, electrically programmable logic and memory devices and standard cell-based devices, as well as application specific integrated circuits (ASICs). Some other possibilities for implementing aspects of the valuator include: microcontrollers with memory (such as electronically erasable programmable read only memory (EEPROM)), embedded microprocessors, firmware, software, etc. Furthermore, aspects of the valuator may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various circuits disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and HLDL, formats supporting register level description languages like RTL, and formats supporting geometry description languages such as GDSII, GDSIII, GDSIV, CIF, MEBES and any other suitable formats and languages.

Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the valuator is not intended to be exhaustive or to limit the valuator to the precise form disclosed. While specific embodiments of, and examples for, the valuator are described herein for illustrative purposes, various equivalent modifications are possible within the scope of the valuator, as those skilled in the relevant art will recognize. The teachings of the valuator provided herein can be applied to other processing systems and methods, not only for the systems and methods described above.

The elements and acts of the various embodiments described above can be combined to provide further embodiments. These and other changes can be made to the valuator in light of the above detailed description.

In general, in the following claims, the terms used should not be construed to limit the valuator and corresponding systems and methods to the specific embodiments disclosed in the specification and the claims, but should be construed to include all systems that operate under the claims. Accordingly, the valuator and corresponding systems and methods is not limited by the disclosure, but instead the scope is to be determined entirely by the claims.

While certain aspects of the valuator and corresponding systems and methods are presented below in certain claim forms, the inventors contemplate the various aspects of the valuator and corresponding systems and methods in any number of claim forms. Accordingly, the inventors reserve the right to add additional claims after filing the application to pursue such additional claim forms for other aspects of the valuator and corresponding systems and methods.

1. A system comprising:
a valuation engine comprising at least one processor and at least one database coupled to a plurality of remote clients via a network;
wherein the valuation engine receives a claim that includes transaction data of a transaction between a provider of healthcare services and a claimant;
wherein the valuation engine receives contract data of at least one contract between the provider of healthcare services and a plurality of payers;
wherein the valuation engine receives payment data that includes data of actual payments made by the plurality of payers for the healthcare services;
wherein the valuation engine predicts a value of the claim from the contract data and the payment data, and matches the value to adjudication data received from the plurality of payers;
wherein the valuation engine evaluates credit available to the provider of health care services using the value; and
wherein the valuation engine provides controlled electronic access to the value by at least one third party.

2.-3. (canceled)

4. The system of claim 1, wherein the valuation engine receives adjudication data from a remote client of the plurality of payers.

5. The system of claim 4, wherein the valuation engine generates a predicted value of the claim by automatically reconciling the contract data and the payment data with the adjudication data.

6. The system of claim 1, wherein the at least one database comprises a transaction database, wherein the valuation engine stores the claim in the transaction database, wherein the valuation engine stores the transaction data in the transaction database.

7.-11. (canceled)

12. The system of claim 11, wherein the valuation engine generates a financial score corresponding to the accounts receivable data.

13.-18. (canceled)

19. The system of claim 1, wherein the valuation engine identifies related transactions that correspond to at least one of the claimant, the provider, the plurality of payers, and the healthcare services.

20. The system of claim 1, wherein the valuation engine automatically determines eligibility for the healthcare services corresponding to the claim.

21. (canceled)

22. The system of claim 1, wherein, in generating of the predicted value, the valuation engine evaluates the claim by using the claim and eligibility data to gain pricing information from the contract data.

23.-27. (canceled)

28. The system of claim 1, wherein the valuation engine receives at least one weight coefficient.

29. The system of claim 28, wherein the valuation engine applies the at least one weight to the contract data to determine the value.

30. The system of claim 28, wherein the valuation engine applies the at least one weight to the payment data to determine the value.

31.-32. (canceled)

33. A method comprising:
one or more applications running on at least one processor for performing operations including:
receiving a claim that includes transaction data of a transaction between a provider of healthcare services and a claimant;
receiving contract data of at least one contract between the provider of healthcare services and a plurality of payers;
receiving payment data that includes data of actual payments made by the plurality of payers for the healthcare services;
automatically generating a predicted value of the claim from the contract data and the payment data, and matching the predicted value to adjudication data received from the plurality of payers;
evaluating credit available to the provider of healthcare services using the predicted value; and
providing controlled electronic access to the value by at least one third party.

34.-45. (canceled)

46. The method of claim 33, comprising automatically identifying related transactions that correspond to at least one of the claimant, the provider, the plurality of payers, and the healthcare services.

47.-51. (canceled)

52. The method of claim 33, wherein the generating of the predicted value comprises evaluating the claim by using the claim and eligibility data to gain pricing information from the contract data.

53.-55. (canceled)

56. The method of claim 33, comprising adding the predicted value of the claim to an available line of credit of the provider, wherein the credit available to the provider comprises the line of credit.

57. The method of claim 56, comprising subtracting the predicted value of the claim from the available line of credit of the provider when the claim is paid.

58.-61. (canceled)

62. The method of claim 33, comprising receiving at least one weight coefficient.

63. The method of claim 62, comprising applying the at least one weight to the contract data to determine the value.

64. The method of claim 62, comprising applying the at least one weight to the payment data to determine the value.

65.-66. (canceled)

67. A method comprising:
one or more applications running on at least one processor for performing operations including:
receiving a claim that includes transaction data of a transaction between a provider of healthcare services and a claimant;
receiving contract data of at least one contract between the provider of healthcare services and a plurality of payers, wherein the at least one contract corresponds to the healthcare services provided in the transaction;
receiving payment data that includes historical data of actual payments made by a the plurality of payers for the healthcare services;
receiving adjudication data from the payer plurality of payers; generating a predicted value of the claim by using the contract data and the payment data, wherein the generating of the predicted value comprises automatically reconciling the contract data and the payment data with the adjudication data, and
matching the predicted value to the adjudication data; and
evaluating credit available to the provider of health care services using the predicted value.
